(19) United States
(12) Patent Application Publication
(10) Pub. No.: US 2017/0140629 A1
(43) Pub. Date: May 18, 2017

(54) Real-Time Harm Prevention Through Feedback System With Automatic Detection of Human Behavioral and Emotional States

(71) Applicant: International Business Machines Corporation, Armonk, NY (US)

(72) Inventors: Benjamin D. Briggs, Waterford, NY (US); Lawrence A. Clevenger, LaGrangeville, NY (US); Leigh Anne H. Clevenger, Rhinebeck, NY (US); Jonathan H. Connell, II, Conrtlandt Manor, NY (US); Nalini K. Ratha, White Plains, NY (US); Michael Rizzolo, Albany, NY (US)

(21) Appl. No.: 14/945,179

(22) Filed: Nov. 18, 2015

(51) Int. Cl. G08B 21/04

(52) U.S. Cl. CPC G08B 21/0461

(57) ABSTRACT

The present invention provides techniques for leveraging the sensing capabilities of wearable mobile technology, such as a smartwatch, to provide real-time harm prevention. In one aspect of the invention, a method for harm prevention is provided. The method includes the steps of: collecting real-time data from at least one user, wherein the data is collected via a mobile device worn by the user (e.g., a smartwatch); analyzing the real-time data collected from the user to determine whether the real-time data indicates an emergency situation exists; and undertaking an appropriate action if the real-time data indicates that an emergency situation exists, otherwise continuing to collect data from the user in real-time. Third party data relating to potential source of harm to the user may also be obtained (e.g., from a weather service, newsfeeds, etc.)

### FIELD OF THE INVENTION

The present invention relates to harm prevention techniques, and more particularly, to leveraging the sensing capabilities of wearable mobile technology, such as a smartwatch, to provide real-time harm prevention based on user data collected via the smartwatch.

### BACKGROUND OF THE INVENTION

Current harm prevention techniques leveraging mobile technology permit a person to track the location of another and, in the face of a potential threat, take action to prevent harm. For instance, this technology might be employed by a parent or guardian to keep watch over a child.

There are, however, some notable drawbacks to conventional harm prevention systems. Namely, these systems are based on mobile devices carried by a person, such as a mobile phone. In the case of a potential emergency, the user is contacted through the mobile phone and an assessment is made of the threat, if any. However, if the user is incapacitated (due, e.g., to a medical emergency) or is for some other reason unable to answer the phone, then a complete and accurate assessment of the situation cannot be made. For instance, the user might simply not realize that a call is coming through and thus not answer his/her phone. If in fact there is no threat present, then this triggers a false alarm scenario where, for instance, emergency and/or medical personnel are unnecessarily called into action. Avoiding false alarm scenarios is important since they tie up resources that might be needed in other emergency situations.

Therefore, improved techniques for monitoring and harm prevention would be desirable.

### SUMMARY OF THE INVENTION

The present invention provides techniques for leveraging the sensing capabilities of wearable mobile technology, such as a smartwatch, to provide real-time harm prevention. In one aspect of the invention, a method for harm prevention is provided. The method includes the steps of: collecting real-time data from at least one user, wherein the data is collected via a mobile device worn by the user (e.g., a smartwatch); analyzing the real-time data collected from the user to determine whether the real-time data indicates an emergency situation exists; and undertaking an appropriate action if the real-time data indicates that an emergency situation exists, otherwise continuing to collect data from the user in real-time. Third party data relating to potential source of harm to the user may also be obtained (e.g., from a weather service, newsfeeds, etc.)

A more complete understanding of the present invention, as well as further features and advantages of the present invention, will be obtained by reference to the following detailed description and drawings.

### BRIEF DESCRIPTION OF THE DRAWINGS

FIG. 1 is a diagram illustrating an exemplary methodology for harm prevention according to an embodiment of the present invention;

FIG. 2 is a diagram illustrating an exemplary system for harm prevention according to an embodiment of the present invention; and

FIG. 3 is a diagram illustrating an exemplary apparatus for performing one or more of the methodologies presented herein according to an embodiment of the present invention.

### DETAILED DESCRIPTION OF PREFERRED EMBODIMENTS

As provided above, current harm prevention techniques relying on mobile technology provide only limited information on the user being monitored, and require that the user actively provide feedback through their mobile device, such as a mobile phone, as to his/her situation, condition, etc. Without active feedback from the user, a complete assessment of the situation cannot be made, and can lead to incorrect response actions being undertaken. Take for instance, the situation where a child is being remotely monitored by a parent or guardian via the child's mobile phone. If an emergency situation occurs at the child's location, but the parent/guardian is not able to reach the child on his/her mobile phone, then the parent/guardian might choose to alert authorities asking them to send personnel to that location. If in fact no emergency is present, then this type of false alarm scenario unnecessarily utilizes valuable resources. For example, the child might not know that a call is coming through (e.g., the child might be in a public space where a ring tone would be disturbing to others—so the child silences his/her mobile phone). The parent/guardian, knowing that there is an emergency situation at the child's location (e.g., a severe impending storm, tornado, etc.), will have stress not knowing what is happening since they are unable to assess the child's situation/condition without talking to him/her. In that situation, the parent or guardian might choose to alert authorities—potentially leading to a false alarm scenario. To give another example, the child might be incapacitated based on a medical emergency, and unable to answer his/her mobile phone. The parent/guardian would not know why the child is not answering the phone, and cannot fully know the extent of the situation without talking to the child. Again an inaccurate response may occur in that situation. Further, even in situations where the parent or guardian is able to connect with the child, the child might not be able to provide an accurate account of his/her situation/condition, etc. For instance, a child might not know or be able to assess the extent of a medical situation or condition, the true dangers of an impending weather threat, etc.

Advantageously, the present techniques leverage the capabilities of emerging smartwatch technology to (passively) capture vital data for a user(s) to enable monitoring and harm prevention techniques to be implemented based on the most accurate and up-to-date (i.e., real-time) information possible. The present techniques enable an accurate assessment of the threat condition without the user needing to actively provide feedback. For instance, as will be described in detail below, the present techniques employ the sensing, data collection, and data processing capabilities of wearable mobile technology (such as smartwatches) to passively monitor various parameters of a user, such as biological/physiological statistics, location information, etc. in conjunction with external data, such as weather data, news feeds, etc. to accurately assess and respond to threat conditions.

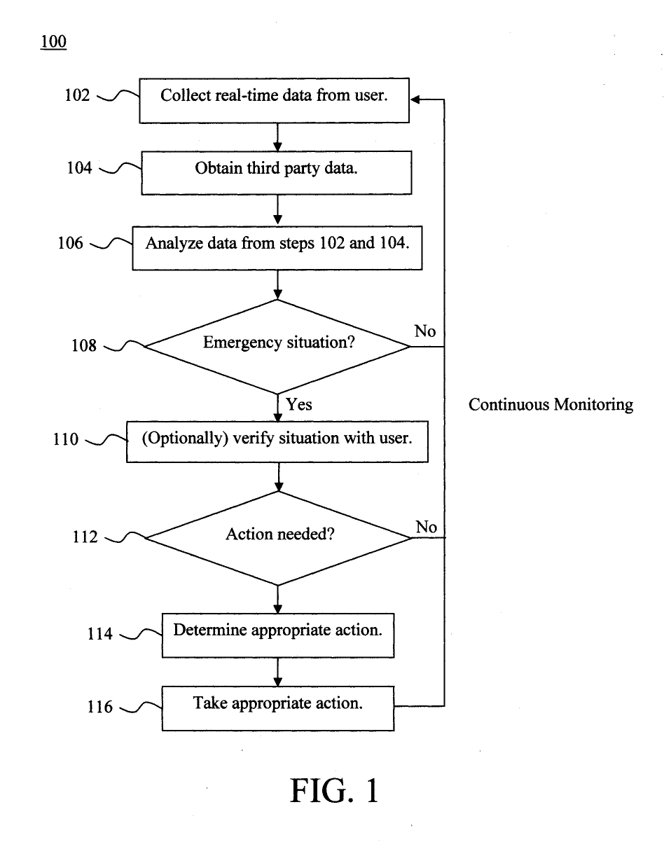

An overview of the present techniques is now provided by way of reference to methodology 100 of FIG. 1. It is notable that for ease and clarity of description, the following exemplary embodiment is described in the context of the process employed for monitoring a single individual, e.g., such as when a parent or guardian is monitoring a child. However, the present techniques can be applied in the same manner described to monitor multiple individuals, e.g., multiple family members. For example, the parent or guardian may also be monitored using the present techniques. That way if the parent or guardian experiences an emergency, then the proper authorities can be (automatically) alerted thereby preventing harm to the parent/guardian as well as the child/children under his/her care. Further, as will be described in detail below, monitoring of the parent/guardian can be useful in the situation where the parent/guardian that is closest in location to the child can be alerted when the child is in a position of danger and thus in the best position to act swiftly. Further, for the sake of generality, reference is made herein to users (of the present monitoring system) in performance of the present techniques. For instance, in the context of the example provided above where a parent or guardian is monitoring a child, then the child might be referred to herein as the user (or in the case of children first, second, third, etc. users).

In step 102, real-time data is gathered from the user and/or from the user's surroundings. As highlighted above, according to an exemplary embodiment, the present techniques for behavior monitoring and feedback control are implemented using wearable mobile technology, such as a commercially available smartwatch. A smartwatch, or other suitable wearable technology, may also be referred to herein as a wearable mobile feedback controller or simply a wearable controller. Smartwatches which may be used in accordance with the present techniques are available from companies such as Motorola™ (e.g., the MOTO 360), Samsung™ (e.g., Samsung Gear™), Apple™ (e.g., the Apple Watch™), etc.

Different smartwatches have different capabilities, such as a variety of different sensors, user interactive features such as voice commands, audible/motion alarms/alerts, etc. By way of example only, some of the smartwatch technology that is leveraged for the present techniques includes the following:

Sensors—the present techniques envision use of one or more sensors proximate to the user (also referred to herein as proximal sensors). These are sensors that can measure physical/physiological conditions of the user. These types of sensors generally require contact with the user to function, and thus are also referred to herein as contact sensors. For instance, one such contact sensor is an electrodermal activity or EDA sensor. EDA sensors measure the electrical characteristics of the skin. The electrical characteristics of the skin are controlled, at least in part, by the state of sweat glands in the skin, which in turn are regulated by the sympathetic nervous system. Thus, EDA sensors can gauge sympathetic and nervous responses.

Other contact sensors useful for the present techniques include pulse oximeters and heart rate sensors. A pulse oximeter measures a person's blood oxygen levels often via a sensor placed on a part of the body such as a fingertip. Similarly, a heart rate sensor measures a person's heart rate or pulse (generally in beats per minute), e.g., via a sensor placed on the chest or wrist.

Other useful proximal sensors are trajectory and pose sensors. For instance, an accelerometer can be used to detect the user's movement, speed and direction. A gyroscope sensor (often used in conjunction with an accelerometer) detects direction or orientation. A rate gyroscope similarly measures the rate of change of angle with time. A global positioning system or GPS provides location information.

Yet another type of sensor that is useful for the present techniques is an environmental sensor. For instance, a compass and/or a magnetometer (which measures the direction of magnetic fields) can be used to determine the physical position of the user. A barometer, air temperature sensors, wind speed sensors, etc. can be used to assess environmental conditions such as air pressure, temperature, wind velocity etc.

It is notable that the present sensor data can be collected via the smartwatch technology passively, i.e., without the user actively providing the data. Namely, since the various sensors incorporated in the smartwatch technology are worn by the user, the above-described sensor data can be collected from the user in real-time regardless of whether the user is actively communicating (via voice or text, etc.) with the parent/guardian. Thus, in the instance where the user is either not in communication, or not able to communicate with the parent or guardian, comprehensive real-time data is still being collected.

Data can also be obtained from third party sources. See step 104. For instance, data may be gathered from weather services, newsfeeds, etc. to assess whether any potential emergencies exist at the user's location. For example, weather service data may indicate the presence of a natural emergency, such as a severe storm, tornado, earthquake, etc. That data may be cross-checked with the location data obtained from the user to determine whether the user is in any potential danger. Newsfeeds can also provide useful information, such as hazardous conditions due to a fire, an accident, bad road conditions, etc. This third party data can be readily obtained through the Internet.

In step 106, the data gathered in steps 102 and 104 is analyzed, and in step 108 a determination is made as to whether (or not) the data analysis indicates that a potential emergency situation exists. This determination may involve data fusion from multiple sensors. For instance, if the sensor data indicates that the user has an elevated heart rate, but also indicates that the user is participating in a sporting event, then the determination might be made that the situation is normal and no emergency situation is present. By contrast, if the data indicates that the user has an elevated pulse/heart rate, or other indicators of stress, but that the user is at a location typically associated with low user stress, such as when the user is at a movie theater, a restaurant, etc., then it may be determined that the user's condition is unusual, potentially indicating an emergency situation. Other, non-limiting scenarios can include, e.g., when the data indicates that the user has a low heart rate, this might be abnormal when the user is at school or work (indicating a potential medical emergency), but normal if it is at night and the user is home (and resting/sleeping). Further, if the data indicates that the user is moving in the direction of a potential hazard, such as a busy road, a cliff, the area of an impending storm, a region experiencing an emergency situation such as a fire, an accident, etc., then a determination may be made that an emergency situation is present.

If it is determined in step 108 that (No) indicators of an emergency situation are not present, then real-time gathering of the user data and collection of updated third party data continues in the manner describe above. On the other hand, if it is determined in step 108 that (Yes) the data collected (in steps 102 and 104) and analyzed (in step 106) indicates an emergency situation, then a determination of the appropriate action has to be made.

Optionally, however, an attempt can first be made in step 110 to verify the situation with the user. For instance, upon a determination having been made that a potentially hazardous condition is present, a message (voice, text, etc.) and/or any various other alerts or alarms can be used to get the user's attention, let them know of the threat assessment, and check on their wellbeing. For instance, a text message can be sent to the user's smartwatch inquiring about the potential hazard, e.g., “are you okay?”, “are you experiencing a medical condition?” etc. The message can be accompanied by other alerts meant to grab the user's attention. For instance, an audible alarm can alert the user to view text on his/her smartwatch display. The alarm can be intensified if the user does not reply. Similarly, voice commands can operate in the same general manner. Visual alerts can be implemented by flashing different images and/or colors on the smartwatch's display. For example, under normal conditions the watch display might be blue. When an alert is generated, the color of the display can change (e.g., to red or flashing red). The frequency of the flashing can increase until it catches the user's attention. The display can return to a normal color/stop flashing when the user replies. Additionally, a vibrating alert feature may be used to get the user's attention. For instance, when the user's smartwatch vibrates, the user will know to read information off of the display.

In this manner, the user is given the opportunity to verify whether an emergency situation actually exists. For example, the user might reply to the text message with an indication that, yes—the user acknowledges the presence of their elevated heart rate, but that the user is exercising, and therefore the detected vitals are normal. The verification process may be performed by contacting the user directly via the user's smartwatch. However, attempts may also be made to contact the user through other means as well, such as through the user's smartphone. Further, as provided above, the present process may be implemented to monitor multiple individuals, such as a child/children and/or one or more parents/guardians. Therefore, in that case, the request for verification may be sent to multiple parties (e.g., to the child as well as the parent/guardian currently with the child)—any of which can provide verification.

According to an exemplary embodiment, in performing the verifying in step 108, the user may simply be given an option to select either (YES) an emergency situation exists, or (NO) there is no emergency. Upon receipt of a response from the user (or in the absence of a response—e.g., within a predetermined response time and/or after a predetermined number of attempts to reach the user), a determination can then made in step 112 as to whether or not any further action is needed. For instance, if the user responds unequivocally that there is in fact no emergency, then it may be determined in step 112 that (No) further action is not necessary. The real-time gathering of the user data and collection of updated third party data then continues in the manner describe above. On the other hand, if the user doesn't respond (i.e., within the predetermined response time and/or after the predetermined number of attempts to contact the user) or the response is unclear (e.g., if the user responds with an unclear answer, or multiple times with different answers, etc.), then it may be determined in step 112 that (Yes) further action is necessary.

It is notable that while verification can reduce the potential for ‘false-alarm’ scenarios, the procedure described in conjunction with the description of step 110, above, is optional and embodiments are anticipated herein where the following process is performed whenever a potential emergency situation (or a particular type of emergency) exists. For instance, if the above collected/analyzed data indicates that the user is in the path of a severe impending storm, then verification may not be warranted. Namely, if the storm has not reached the user's location, then checking with the user would not likely yield any useful information.

When further action is deemed necessary, the proper action to take is then determined in step 114, and the action is taken in step 116. Of course, this determination can vary based on the situation at hand. For instance, when faced with a medical or non-medical emergency, the proper course of action might be to send medical personnel, police, or fire personnel to the user's location. According to an exemplary embodiment, the present harm prevention system can automatically inform the proper authorities of the situation and the user's current location. Advantageously, with the present techniques, a variety of other useful information can also be provided to emergency response personnel, such as the user's vitals (e.g., heart rate, blood oxygen levels, etc.) in the case of a medical emergency. All of this data can be (passively) gathered via the present smartwatch-based sensor technology—see above. By way of example only, the appropriate course of action can be based on a variety of different pre-run scenarios and predetermined response options.

On the other hand, if the potential emergency situation is an impending severe weather event, such as a tornado, the proper course of action might be to provide the user with directions to a safe location, such as a shelter. This can be provided to the user via his/her smartwatch (and/or other mobile device—i.e., the user's smartphone). Similarly, if the user is headed in the direction of a hazardous situation, such as a fire, a notification can be sent to the user to change his/her route and a suggested rerouting might be provided. In the instance where a user (e.g., a child) is headed towards a dangerous situation, such as a busy road, a cliff, etc., the course of action might be to alert the parent/guardian or other adult that is closest in location to the child of the situation. Various text, voice and/or alerting features that can be implemented in smartwatch technology to communicate with a user were provided above. That parent/guardian is in the best position to act swiftly in response to the potential danger.

As shown in FIG. 1, the present process can be performed in an iterative manner to provide an up-to-date assessment of present conditions. For instance, the above-described procedure of monitoring the real-time user data, third party data, verifications with the user, etc. can be performed in a continuous loop with data collected in real-time. This is useful to address changing conditions. For instance, if the action taken at one iteration is to direct the user away from an impending severe weather event, however updated newsfeed data indicates that the rerouting presents another potential threat, then a different course of action may be calculated.

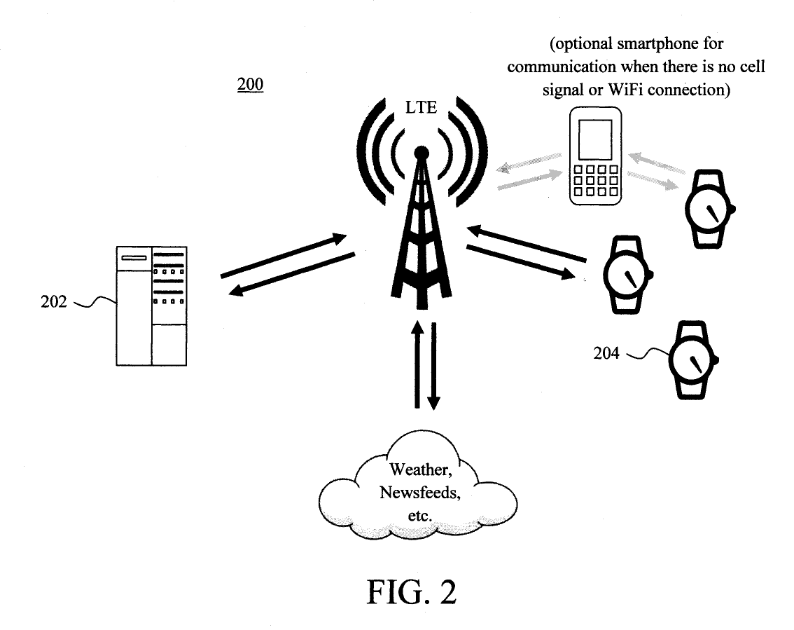

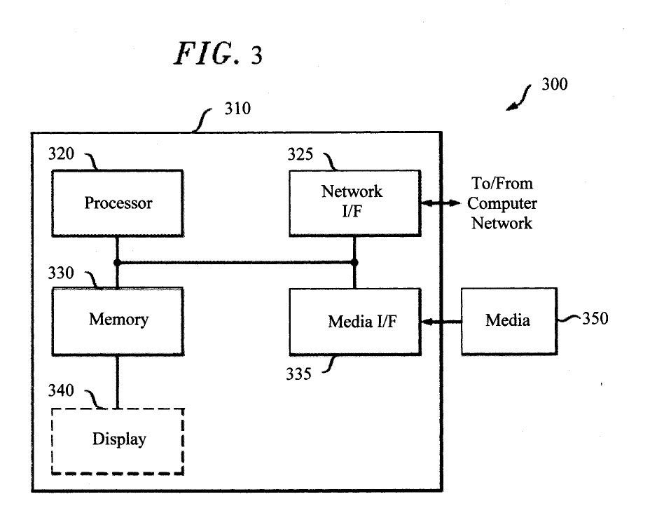

FIG. 2 illustrates an exemplary system 200 in which the present techniques can be implemented. As shown in FIG. 2, a computing device 202 collects data from one or more users via their wearable mobile devices 204, i.e., the above-described smartwatches having a variety of different sensors. Smartwatches without a cell signal or WiFi connection would transmit via an associated smartphone (see FIG. 2) using short-range (100 m) communication such as Bluetooth Low Energy (BLE). The computing device 202 also collects data from third party sources, such as from weather services and/or newsfeeds, etc. The data collected from the users and/or from the third party sources can be obtained wirelessly. In the (non-limiting) example shown in FIG. 2, the wireless connection provided is that of a Long-Term Evolution (LTE) network. An exemplary apparatus that can be configured to serve as computing device 202 is described in conjunction with the description of FIG. 3, below.

According to an exemplary embodiment, the computing device 202 is configured to perform the steps of methodology 100 of FIG. 1. For instance, the computing device 202 collects and analyzes the user data (obtained via the smartwatches 204) and third party data (e.g., weather service, newsfeeds, etc.), (optionally) verifies the situation, and determines/implements the appropriate action, if any, in response to potential emergency situations.

For generality, FIG. 2 depicts a plurality of users being monitored via the present smartwatch technology. As provided above, in one exemplary scenario, the present techniques are implemented by a parent/guardian to monitor the well being of a child or children. As also provided above, the parent or guardian in that scenario may also be monitored via the present process (for instance to determine the well being of the child's caregiver and/or to determine the person in closest proximity to the child to offer harm prevention actions). Thus, in that case, the smartwatches 204 shown in FIG. 2 are representative of one or more children and one or more parent/guardian users.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Turning now to FIG. 3, a block diagram is shown of an apparatus 300 for implementing one or more of the methodologies presented herein. By way of example only, apparatus 300 can be configured to implement one or more of the steps of methodology 100 of FIG. 1.

Apparatus 300 includes a computer system 310 and removable media 350. Computer system 310 includes a processor device 320, a network interface 325, a memory 330, a media interface 335 and an optional display 340. Network interface 325 allows computer system 310 to connect to a network, while media interface 335 allows computer system 310 to interact with media, such as a hard drive or removable media 350.

Processor device 320 can be configured to implement the methods, steps, and functions disclosed herein. The memory 330 could be distributed or local and the processor device 320 could be distributed or singular. The memory 330 could be implemented as an electrical, magnetic or optical memory, or any combination of these or other types of storage devices. Moreover, the term “memory” should be construed broadly enough to encompass any information able to be read from, or written to, an address in the addressable space accessed by processor device 320. With this definition, information on a network, accessible through network interface 325, is still within memory 330 because the processor device 320 can retrieve the information from the network. It should be noted that each distributed processor that makes up processor device 320 generally contains its own addressable memory space. It should also be noted that some or all of computer system 310 can be incorporated into an application-specific or general-use integrated circuit.

Optional display 340 is any type of display suitable for interacting with a human user of apparatus 300. Generally, display 340 is a computer monitor or other similar display.

Although illustrative embodiments of the present invention have been described herein, it is to be understood that the invention is not limited to those precise embodiments, and that various other changes and modifications may be made by one skilled in the art without departing from the scope of the invention.

What is claimed is:

1. A method for harm prevention, comprising the steps of:
collecting real-time data from at least one user, wherein the data is collected via a mobile device worn by the user;
analyzing the real-time data collected from the user to determine whether the real-time data indicates an emergency situation exists; and
undertaking an appropriate action if the real-time data indicates that an emergency situation exists, otherwise continuing to collect data from the user in real-time.

2. The method of claim 1, further comprising the step of:
obtaining third party data relating to potential source of harm to the user.

3. The method of claim 2, wherein the third party data is obtained from at least one of a weather service and a newsfeed.

4. The method of claim 2, further comprising the step of:
analyzing the real-time data collected from the user in combination with the third party data to determine whether an emergency situation exists.

5. The method of claim 1, further comprising the step of:
determining the appropriate action to take.

6. The method of claim 1, further comprising the step of:
contacting the user to verify that an emergency situation exists.

7. The method of claim 6, further comprising the step of:
determining whether further action is needed after contacting the user.

8. The method of claim 6, wherein the step of contacting the user comprises the step of:
setting at least one of i) a predetermined number of attempts to get a response, and ii) a predetermined response time.

9. The method of claim 1, comprising a plurality of users.

10. The method of claim 1, wherein at least one of the plurality of users is a child.

11. The method of claim 10, wherein at least one of the plurality of users is a guardian of the child.

12. The method of claim 1, wherein the real-time data collected from the user comprises physiological data for the user selected from the group consisting of: skin electrical characteristics, blood oxygen levels, heart rate, pulse, and combinations thereof.

13. The method of claim 1, wherein the real-time data collected from the user comprises trajectory data for the user selected from the group consisting of: movement, speed, direction, orientation, location, and combinations thereof.

14. The method of claim 1, wherein the real-time data collected from the user comprises environmental data selected from the group consisting of: air pressure, temperature, wind velocity, and combinations thereof.

15. The method of claim 1, wherein the mobile device worn by the user comprises at least one sensor selected from the group consisting of: an electrodermal activity (EDA) sensor, a pulse oximeter sensor, a heart rate sensor, and combinations thereof.

16. The method of claim 1, wherein the mobile device worn by the user comprises at least one sensor selected from the group consisting of: a gyroscope sensor, a global positioning system (GPS) sensor, and combinations thereof.

17. The method of claim 1, wherein the mobile device worn by the user comprises at least one sensor selected from the group consisting of: a barometer, an air temperature sensor, a wind speed sensor, and combinations thereof.

18. The method of claim 1, wherein the mobile device worn by the user comprises a smartwatch.

19. The method of claim 1, wherein the appropriate action comprises alerting at least one of: the user, emergency personnel, and another user.

20. A computer program product for harm prevention, the computer program product comprising a computer readable storage medium having program instructions embodied therewith, the program instructions executable by a computer to cause the computer to:
collect real-time data from at least one user, wherein the data is collected via a mobile device worn by the user;
analyze the real-time data collected from the user to determine whether the real-time data indicates an emergency situation exists; and
undertake an appropriate action if the real-time data indicates that an emergency situation exists, otherwise continuing to collect data from the user in real-time.
